(19) United States
(12) Patent Application Publication
(10) Pub. No.: US 2025/0377913 A1
(43) Pub. Date: Dec. 11, 2025

(54) INFORMATION PROCESSING SYSTEM, INFORMATION PROCESSING DEVICE, CONTROL METHOD FOR INFORMATION PROCESSING DEVICE, AND STORAGE MEDIUM

(71) Applicant: CANON KABUSHIKI KAISHA, Tokyo (JP)

(72) Inventor: YOKO SAINO, Tokyo (JP)

(21) Appl. No.: 19/227,676

(22) Filed: Jun. 4, 2025

(30) Foreign Application Priority Data
Jun. 11, 2024 (JP) 2024-094507

(51) Int. Cl. G06F 9/451; G06F 3/04842

(52) U.S. Cl. CPC G06F 9/451; G06F 3/04842

(57) ABSTRACT

An information processing device configured to transmit a rendering result obtained by processing web content to another information processing device and cause the other information processing device to display the rendering result, the information processing device comprises a reception unit configured to receive information related to a user operation on the web content from the other information processing device; an element acquisition unit configured to acquire an element that is a target of the user operation; an information acquisition unit configured to acquire detailed information of the element when the element is a predetermined element; and a transmission unit configured to transmit the detailed information to the other information processing device.

### BACKGROUND

### Field of the Technology

The present disclosure relates to an information processing system, an information processing device, a control method for the information processing device, and a storage medium, and particularly relates to a technique related to UI display control.

### Description of the Related Art

A user browsing a web page using a web browser is a well known matter. Web browsers are installed not only in personal computers but also in mobile devices such as smartphones and tablets. Thus, browsing web pages outdoors is a common practice.

The web browser executes acquiring web content (such as HTML document, JavaScript, or CSS) designated by a URL, analyzing the web content, executing processing for generating a rendering result through rendering processing, and displaying the web content designated by the user. When a user operation for the rendering result is performed using a mouse, a touch panel, a keyboard, or the like, a rendering result corresponding to the operation is displayed. Here, a program in charge of the processing for generating a rendering result for web content by using the web content as an input is referred to as a browser engine. Generally, processing for a browser engine and for the user operation thereon as well as processing for outputting the rendering result generated by the browser engine are all executed inside a single device. Hereinafter, a web browser of this format is referred to as an embedded browser.

The embedded browser may not be installable devices focusing on resource saving. In this context, there is a format known as a cloud browser with which a server including the browser engine generates a rendering result and a client device displays the rendering result. The client device is mainly in charge of input and output including designation of a URL, displaying of a rendering result, a user operation, and the like. The cloud server acquires web content, analyzes the web content, and generates a rendering result through rendering processing. With the processing thus dispersed, it is possible to display and operate the web content even with devices focusing on resource saving. For example, the rendering result is visualized by the server, and the client device displays the image transmitted from the server.

According to the disclosure of Japanese Patent Laid-Open No. 2014-182793, a rendering result generated on a server side is visualized to be displayed on a client device.

Incidentally, as the rendering result, a momentary change in UI in response to a user operation may be displayed, and then a result of transition to another URL may be finally displayed. For example, with HTML, a link destination URL can be designated using an anchor element. When this element is clicked on a general web browser, the color of the clicked element or a rectangle surrounding the element is momentarily rendered and displayed in order to indicate which element is clicked. Thereafter, the link destination of the anchor element is displayed as the final rendering result.

However, when the rendering is performed for displaying a momentary change in UI with the cloud browser, processing needs to be executed for generating a rendering result for the momentary change in UI, converting the rendering result into a video or an image, and transmitting the result to the client device. Therefore, it takes time until the final transition result is displayed. On the other hand, if the display of the momentary change in UI is omitted, the user cannot recognize the clicked (or touched) portion. This means that unintentional selection (pressing) of an element cannot be recognized until the rendering is completed.

### SUMMARY

The present disclosure has been made in view of the above-described problems, and provides a technique for enabling an element selected by a user to be swiftly recognized while achieving a shorter processing time.

According to one aspect of the present disclosure, there is provided an information processing system configured to transmit a rendering result obtained by processing web content in a first information processing device to a second information processing device and cause the second information processing device to display the rendering result, wherein the first information processing device includes a reception unit configured to receive information related to a user operation on the web content from the second information processing device, an element acquisition unit configured to acquire an element that is a target of the user operation, an information acquisition unit configured to acquire detailed information of the element when the element is a predetermined element, and a transmission unit configured to transmit the detailed information to the second information processing device, and the second information processing device includes a reception unit configured to receive the detailed information, and a rendering unit configured to render, on the web content, a user interface related to the user operation, based on the detailed information.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 illustrates a configuration example of an information processing system according to an embodiment.

FIG. 2 is a block diagram illustrating a hardware configuration of a cloud server according to an embodiment.

FIG. 3 is a block diagram illustrating a hardware configuration of a client device according to an embodiment.

FIG. 4 is a functional block diagram of the client device according to an embodiment.

FIG. 5 is a functional block diagram of the cloud server according to an embodiment.

FIG. 6 is a flowchart illustrating a flow of processing in the cloud server according an embodiment.

FIG. 7 is a flowchart illustrating a flow of processing in the client device according to an embodiment.

FIG. 8A and FIG. 8B are diagrams illustrating examples of a UI rendered by the client device according to an embodiment.

FIG. 9 illustrates an example of a UI rendered by the client device according to an embodiment.

FIG. 10 is a diagram illustrating an example of a UI rendered by the client device according to an embodiment.

FIG. 11 is a diagram illustrating an example of a predetermined element according to an embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

In the present embodiment, a cloud browser will be described with which information of a selected (clicked or touched) element is transmitted from a cloud server to a client device to cause some changes in user interface (UI) to be generated and displayed on a client device.

### System Configuration

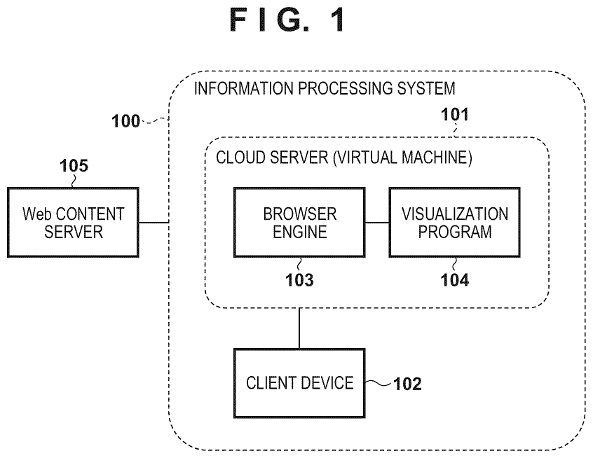

FIG. 1 is a diagram illustrating a configuration of an information processing system according to the present embodiment, and is a diagram illustrating a configuration of a cloud browser. Reference numeral 100 denotes an information processing system including a cloud server 101 and a client device 102.

Reference numeral 101 denotes an information processing device functioning as the cloud server. The cloud server 101 includes a browser engine 103 and a visualization program 104. The cloud server 101 operates on a virtual machine in a cloud environment. Various device resources required for a PC are virtually allocated to the virtual machine. Therefore, the browser engine running on the virtual machine can operate in the same manner as the browser engine running on the PC.

Reference numeral 102 denotes an information processing device functioning as the client device on the side of a user who browses a web page. The client device 102 performs transmission of a user operation to the cloud server 101, displaying of a received image of a web page generated by the cloud server 101, and the like.

Reference numeral 103 denotes a browser engine. The browser engine 103 analyzes web content acquired from the web content server 105 and executes rendering processing or the like to create a rendering result for the web page. The browser engine 103 parses an HTML document and CSS, and generates a DOM tree and a CSS Object Model (CSSOM) describing the respective elements in a form of a tree structure. The browser engine 103 further generates a render tree representing a rendering structure based on the trees. The browser engine 103 executes a script by parsing and compiling JavaScript into a machine language.

Reference numeral 104 denotes a visualization program. The visualization program 104 converts the rendering result generated by the browser engine 103 into image data of, for example, an image format such as PNG or JPEG. Reference numeral 105 denotes a web content server. The web content server 105 is a server that provides web content such as HTML, JavaScript, and CSS based on a request.

### Hardware Configuration of Cloud Server

FIG. 2 is a block diagram illustrating an example of a hardware configuration of the cloud server 101 according to the present embodiment. The cloud server 101 includes, as main components, a controller unit 201 that controls the entire cloud server 101, a storage device 205, and a communication device 206.

The controller unit 201 includes a CPU 202, a ROM 203, and a RAM 204. The CPU 202 is one or more CPUs that execute processing of each processing unit in the cloud server 101. The ROM 203 stores various programs executed by the CPU 202, data required by the programs, and the like. The RAM 204 includes an SRAM, a DRAM, and the like, and stores a program control variable and the like. Various work buffers are also stored in the RAM 204. The storage device 205 including a hard disk and the like stores file data such as documents and images. The communication device 206 is an interface for connecting to a network. A LAN may be used for the connection.

The cloud server 101 executes a program of the browser engine 103 that accesses the web content server 105 to acquire web content, interprets the acquired web content, and generates a rendering result. The cloud server 101 determines the element that is the input operation target based on the input operation received from the client device. Further, a rendering result corresponding to the input operation is generated. Furthermore, the cloud server 101 transmits the element information that is the input operation target to the client device 102. The rendering result generated by the browser engine 103 is visualized by using the visualization program 104 and is transmitted to the client device 102. Each program is stored in the ROM 203 or the storage device 205, and is loaded onto the RAM 204 for the processing to be executed by the CPU 202. The web content server 105 and the client device 102 can communicate with each other via the communication device 206.

### Hardware Configuration of Client Device

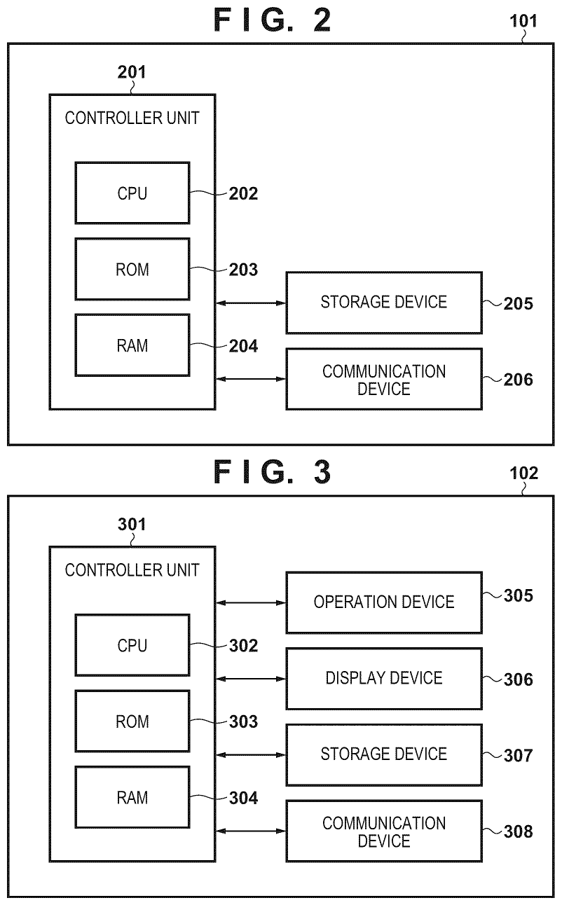

FIG. 3 is a block diagram illustrating an example of a hardware configuration of the client device 102 according to the present embodiment. The client device 102 includes, as main components, a controller unit 301 that controls the entire client device 102, an operation device 305, a display device 306, a storage device 307, and a communication device 308.

The controller unit 301 includes a CPU 302, a ROM 303, and a RAM 304. The CPU 302 is one or more CPUs that execute processing of each processing unit in the client device 102. The ROM 303 stores various programs executed by the CPU 302, data required by the programs, and the like. The RAM 304 includes an SRAM, a DRAM, and the like, and stores a program control variable and the like. Various work buffers are also stored in the RAM 304.

The operation device 305 includes a keyboard, a touch panel, a mouse, and the like, and is used by the user to perform various input operations. The display device 306 is an LCD, an LED display, or the like for providing display or notification to the user. The storage device 307 including a hard disk and the like stores file data such as documents and images. The communication device 308 is an interface for connecting to a network. A LAN may be used for the connection.

The client device 102 executes various programs such as a program related to a UI such as a URL input field and a web page display field, and a program related to communication transmission and reception. Each program is stored in the ROM 303 or the storage device 307, and is loaded onto the RAM 304 for the processing to be executed by the CPU 302.

A UI related to displaying and an image received from the cloud server 101 are rendered by the display device 306. URL designation and an operation on a web page are received by the operation device 305. Communication with the cloud server 101 can be performed via the communication device 308.

### Functional Configuration of Client Device

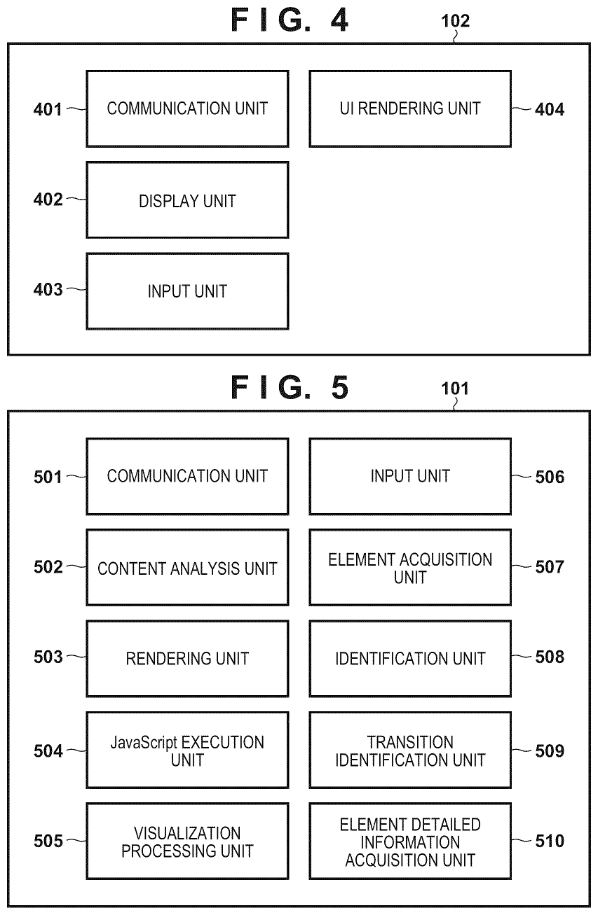

FIG. 4 is a block diagram schematically illustrating software functions of the client device 102 according to the present embodiment. Each unit will be described. Each unit is controlled by a program stored in the ROM 303.

A communication unit 401 performs transmission and reception to and from the cloud server 101. An image that is the rendering result generated by the cloud server 101 is received from the cloud server 101, and the element information is received from the cloud server 101. The content of a user operation (such as mouse input or touch input) received by the client device 102 and the coordinates thereof are transmitted to the cloud server 101.

A display unit 402 displays an image that is the rendering result received by the communication unit 401, displays a UI such as a URL input field or a dialog generated by the client device 102, and displays a UI rendered by a UI rendering unit 404 described below.

An input unit 403 receives a user operation. A mouse input or a touch input (such as click, double click, mouse down, mouse up, mouse move, touch start, touch end, or touch move) is received from the operation device 305 including a touch panel, a mouse, or the like, and an input of coordinates is received. The UI rendering unit 404 renders a user interface related to a user operation on the web content based on detailed information of the element received by the communication unit 401. For example, rectangular coordinates of an element selected by a user operation are received as the detailed information of the element, and a rectangle surrounding the element is rendered as a UI on the image that is the rendering result.

### Functional Configuration of Cloud Server

FIG. 5 is a block diagram schematically illustrating a software function of the cloud server 101 according to the present embodiment. Each unit will be described. Each unit is controlled by a program stored in the ROM 203.

A communication unit 501 performs transmission and reception to and from the client device 102 and acquisition of web content from a web content server. Furthermore, the communication unit 501 also transmits an image that is the rendering result generated by the cloud server 101 and receives user operation information from the client device 102.

A content analysis unit 502 executes analysis processing on the web content received from the web content server 105. An HTML document, CSS, and JavaScript are parsed, and a DOM tree, a CSSOM, a render tree, and an Abstract Syntax Tree (AST) of JavaScript are generated.

A rendering unit 503 generates a rendering result based on the render tree generated by the content analysis unit 502 and a result of execution by a JavaScript execution unit 504. The rendering unit 503 manages the status of a change in the rendering result, and if the rendering result changes, notifies another processing unit of the change.

The JavaScript execution unit 504 executes JavaScript using the AST generated by the content analysis unit 502 as an input. A visualization processing unit 505 executes processing of converting the rendering result generated by the rendering unit 503 into an image. The created image is transmitted to the client device 102 via the communication unit 501.

The input unit 506 implements the content of a mouse input or a touch input, which is user operation information acquired from the communication unit 501, and an input of coordinates, as an operation on the cloud server 101. Examples of the content of the mouse input or the touch input include click, double click, mouse down, mouse up, mouse move, touch start, touch end, touch move, or the like. Thus, a user operation on a web page or a dialog rendered by the rendering unit 503 can be reflected.

An element acquisition unit 507 acquires an element designated by the user operation received from the client device 102. The element acquisition unit 507 acquires an element designated by the coordinate information as the user operation, based on a result of the parsing by the content analysis unit 502.

An identification unit 508 identifies the element acquired by the element acquisition unit 507, and determines whether the element is a predetermined element. The predetermined element is, for example, an anchor element for describing a hyperlink. When this element is clicked, the link destination designated by a href attribute value is obtained as the final rendering result. If the href attribute value is “javascript:void(0)”, even in the case of the anchor element, undefined is obtained as a result of the determination. Thus, no transition to the link destination designated by the href attribute occurs. Still, the rendering unit 503 generates a rendering result enabling the element clicked by the user to be recognized using, for example, a color, a rectangle surrounding the range the element, or the like and then finally generates a rendering result indicating “no transition”, and thus it is determined that there is a change in the rendering result and that the transition occurs.

A transition identification unit 509 identifies a final rendering result with a transition occurring due to a user operation. For example, the rendering unit 503 is configured to issue a notification of the status indicating a change in the rendering result. Then, the notification indicating a change in the rendering result occurring within a certain period is ignored, and the notification issued after a certain period of time is determined to be a notification indicating that the final rendering result is generated based on the user operation. The notification for the rendering result generated within a certain period includes a rendering notification for displaying the clicked element to be recognizable, and this notification is ignored, that is, this rendering result is not visualized.

The visualization processing unit 505 visualizes the rendering result identified by the transition identification unit 509, and causes the communication unit 501 to transmit the image that is the rendering result to the client device 102.

When the identification unit 508 determines that the element is the predetermined element, an element detailed information acquisition unit 510 acquires detailed information of the element. The element detailed information is, for example, information that defines a rectangle surrounding the element. The information defining the rectangle is information including upper left coordinates (x, y) of the rectangle, a width of the rectangle, and a height of the rectangle that are coordinate information of the rectangle for displaying the element as a UI. The acquired element detailed information is transmitted to the client device 102 by the communication unit 501.

### UI Display Example

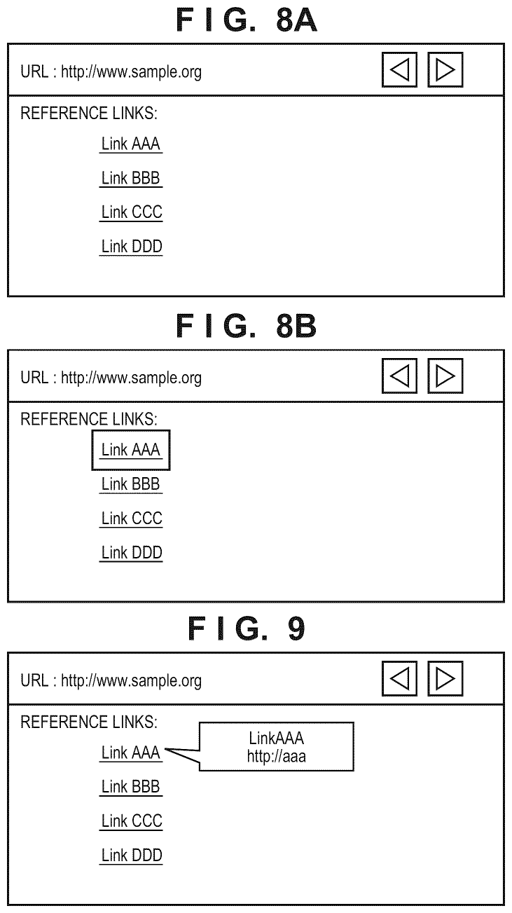

FIG. 8A and FIG. 8B illustrate examples of a UI displayed on the client device according to the present embodiment. FIG. 8A illustrates a UI as a result of displaying a rendering result image of http://www.sample.org/received from the cloud server 101, on the client device 102. This is an example of rendering web content including four anchor elements (LinkAAA, LinkBBB, LinkCCC, and LinkDDD), with designated link destination URLs, arranged side by side.

FIG. 8B illustrates a UI as a result of clicking “LinkAAA” on the UI screen in FIG. 8A. When “LinkAAA” FIG. 8A is clicked, the client device 102 transmits information indicating “click” which is the content of the user operation and information of the clicked coordinates to the cloud server 101. Thereafter, coordinate information of a rectangle surrounding the clicked element is received as element information from the cloud server 101. Then, the client device 102 renders a rectangle on the rendering result image using the upper left coordinates (x, y), the width of the rectangle, and the height of the rectangle which are the coordinate information of the rectangle. The result is the UI screen in FIG. 8B. After the rendering, the client device 102 acquires the rendering result image of the link destination of “LinkAAA” from the cloud server 101 and displays the rendering result image.

### Processing in Cloud Server 101

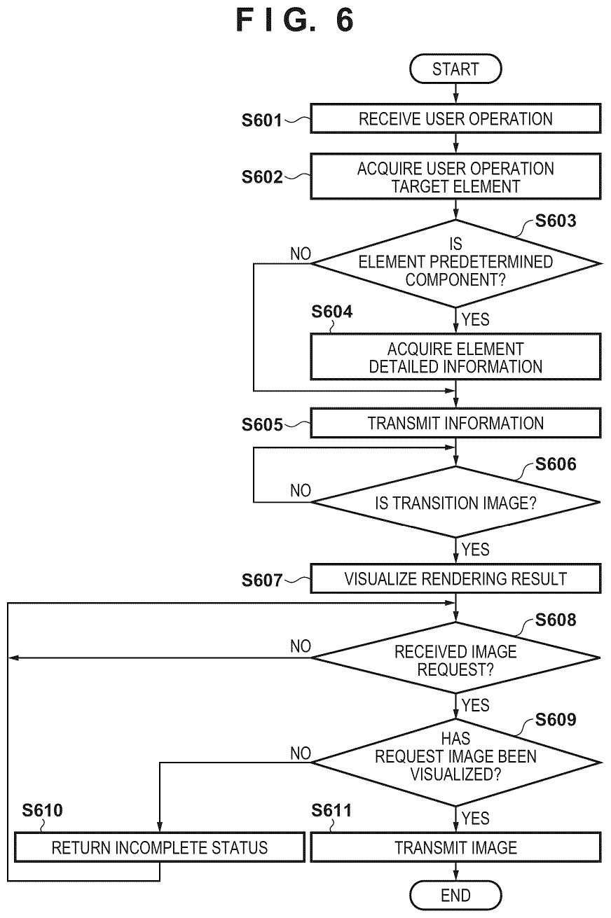

Now, a flow of processing in the cloud server 101 according to the present embodiment will be described with reference to the flowchart in FIG. 6. Here, a description will be first given on processing in which web content is acquired from the web content server 105 via the communication unit 501, a rendering result image is transmitted to the client device 102, and then a user operation on the rendering result image is received.

In S601, the communication unit 501 receives a user operation from the client device 102. Then, the input unit 506 acquires the user operation and the processing proceeds to S602. Here, the user operation is, for example, the content of a mouse input or a touch input and coordinates thereof.

In S602, the element acquisition unit 507 acquires an element that is a target of the user operation, and the processing proceeds to S603. The browser engine 103 has a function of loading Javascript unique to the cloud server 101 onto a web page acquired from the web content server 105 and executing the read Javascript. With this function, it is possible to handle information obtained with Javascript unique to a web page. For example, Javascript Document. elementFromPoint ( ) is executed to acquire an element of designated coordinates.

In S603, the identification unit 508 identifies the user operation target element and determines whether the element is a predetermined component. When the element is determined to be the predetermined element (S603—YES), the processing proceeds to S604. When the element is determined not to be the predetermined element (S603—NO), the processing proceeds to S605. For example, whether it is an anchor element which is the predetermined element is determined.

In S604, the element detailed information acquisition unit 510 acquires element detailed information, and the processing proceeds to S605. The detailed information is, for example, information that defines a rectangle surrounding the element. For example, Element. getBoundingClientRect ( ) is executed by executing the above-described unique Javascript. Thus, information including the upper left coordinates (x, y) of the rectangle surrounding the element, the width of the rectangle, and the height of the rectangle are acquired as the detailed information. The acquired detailed information is transmitted to the client device 102 and used for UI rendering.

In S605, the communication unit 501 transmits information to the client device 102 and the processing proceeds to S606. For example, the URL of the rendering result image corresponding to the user operation is transmitted as the information. When the detailed information is acquired in S604, the acquired detailed information is also transmitted to the client device 102.

In S606, the transition identification unit 509 identifies a rendering result to be visualized and transmitted to the client device 102, and determines whether the rendering result is a transition image involving a page transition. In other words, it is determined whether the rendering result is a rendering result involving page transition of the web content. When it is determined to be the transition image (S606—YES), the processing proceeds to S607. When it is determined not to be the transition image (S606—NO), the processing proceeds to S606. The last image rendered for a user operation is determined as the transition image.

The browser engine 103 has a function of detecting a change in rendering and issuing a notification indicating the change. It is determined to be the last notification, and it is determined to be the rendering result with transition. For example, a notification is to be the last notification when it is the last notification within a certain period or when there is no notification within a predetermined period. The rendering result for the notification is visualized, and is determined to be the rendering result to be transmitted to the client device 102. As a result, it is possible not to visualize the rendering result (rendering result to be displayed only momentarily) in which the element that is the target of the user operation is surrounded by a rectangle.

In S607, the visualization processing unit 505 converts the designated rendering result into an image, and the processing proceeds to S608. For example, the visualization processing unit 505 converts the rendering result determined to be a rendering result involving transition by the transition identification unit 509 into an image file such as PNG or JPEG.

In S608, the communication unit 501 determines whether an image acquisition request has been received from the client device 102 (request reception). When the image acquisition request has been received (S608—YES), the process proceeds to S609. When the image acquisition request has not been received (S608—NO), the processing proceeds to S608. For example, in the image acquisition request, the URL of the rendering result image obtained in S605 is designated, and the image to be acquired by the client device 102 in the subsequent processing can be determined.

In S609, the visualization processing unit 505 determines whether the visualization processing for the image designated by the URL has been completed. When it has been completed (S609—YES), the processing proceeds to S611. When it has not been completed yet (S609—NO), the processing proceeds to S610.

In S610, the communication unit 501 returns status information indicating that the generation of the image has not been completed yet to the client device 102. Then, the processing returns to S608. In S611, the communication unit 501 transmits the rendering result image generated by the visualization processing unit 505 to the client device 102 (result transmission), and the processing ends. Note that the communication unit 501 may transmit status information indicating that the image generation has been completed together with the rendering result image.

### Processing in Client Device 102

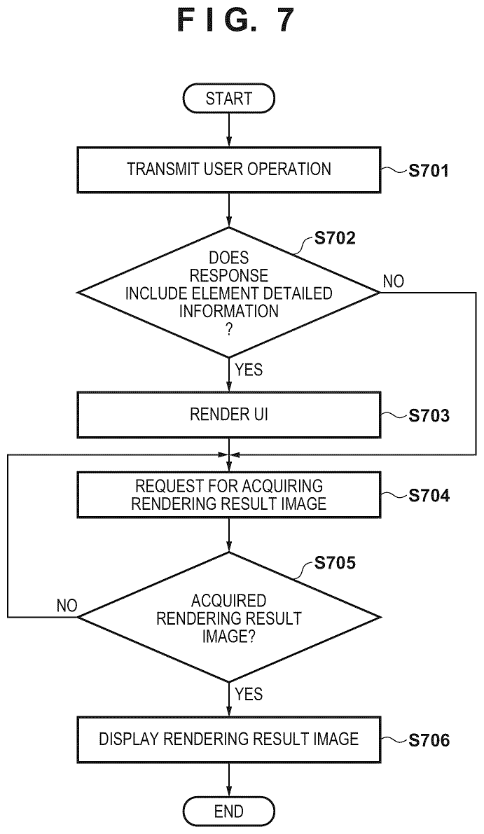

Next, a flow of processing in the client device 102 according to the present embodiment will be described with reference to a flowchart in FIG. 7. In S701, the communication unit 401 transmits information related to the user operation on the rendering result image received by the input unit 403 to the cloud server 101, and the processing proceeds to S702. The information related to the user operation includes, for example, the content of mouse input or touch input and input coordinates thereof.

In S702, the communication unit 401 receives a response from the cloud server 101 and determines whether the response includes the element detailed information. For example, it is determined whether the response includes the element detailed information in addition to the URL of the rendering result image. When the response includes the element detailed information (S702—YES), the processing proceeds to S703. When the response does not include the element detailed information (S702—NO), the processing proceeds to S704.

In S703, the UI rendering unit 404 renders a UI on the rendering result image displayed using the element detailed information, and the processing proceeds to S704. For example, when the user clicks “LinkAAA” on the UI displaying the rendering result image in FIG. 8A, the upper left coordinates (x, y) of the rectangle surrounding the anchor element “LinkAAA”, the width of the rectangle, and the height of the rectangle are received as the element detailed information. A rectangle surrounding “LinkAAA” as illustrated in FIG. 8B is displayed by using this element detailed information.

In S704, the communication unit 401 transmits a request to request for a rendering result image to the cloud server 101 (request transmission), and the processing proceeds to S705. The processing in this step is processing for requesting for a transition image in response to a user operation. For example, by designating the URL received in S702 in this request, it is possible to notify the cloud server 101 of an image to be acquired.

In S705, the communication unit 401 determines whether the rendering result image is acquired from the cloud server 101 (result reception). It is determined whether a rendering result image is included in a response to the request transmitted in S704. When the response includes the status information of the rendering result image generation, the status information can also be acquired. When the rendering result image is successfully acquired (S705—YES), the processing proceeds to S706. When the rendering result image fails to be acquired (S705—NO), the processing returns to S704.

In S706, the display unit 402 displays the acquired rendering result image. For example, when the user selects (clicks) “LinkAAA” illustrated in FIG. 8A, a rectangle surrounding “LinkAAA” is rendered on the client device 102 side as illustrated in FIG. 8B. Thereafter, the image as a result of transition to the destination designated by the href attribute of the anchor element “LinkAAA” is received as the rendering result image and is displayed. Then, the processing ends.

As described above, in the present embodiment, after the UI (rectangle) is rendered by the UI rendering unit 404, the rendering result received from the cloud server 101 is displayed. According to the present embodiment, the cloud server 101 transmits the element detailed information of the user operation target to the client device 102, so that the client device 102 can be in charge of a part of the rendering processing, meaning that the visualization processing for a part of the rendering result can be omitted. According to the present embodiment, the generation of the rendering result for displaying some changes in the UI is performed on the client device side, so that the change in the UI can be displayed on the client device without delay, and the cloud server can more swiftly transition to the generation processing for the rendering result of the transition destination.

### Second Embodiment

In a second embodiment, a description is given on an example of a UI rendered by the UI rendering unit 404 of the client device 102 when element content and transition destination information are received as element detailed information. Note that the same processing as that in the first embodiment are denoted by the same reference numeral and the description thereof is omitted.

### UI Display Example

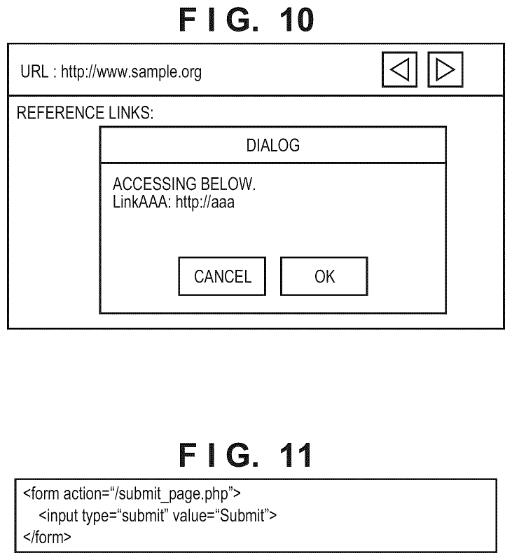

FIG. 9 and FIG. 10 illustrate examples of a UI displayed when the user selects (clicks) “LinkAAA” in FIG. 8A. These are examples of a UI rendered in S702 by the UI rendering unit 404 when “LinkAAA” which is the element content of “LinkAAA” and the URL “http://aaa” as the transition destination are received in S703. The element content and the transition destination URL are shown so that the user can recognize the selected (clicked) element.

FIG. 9 illustrates an example in which a speech bubble including the element content “LinkAAA” and the URL “http://aaa” as the transition destination is displayed based on the position operated by the user. FIG. 10 illustrates an example in which the element content “LinkAAA” and the URL “http://aaa” as the transition destination are displayed in a dialog as the detailed information. The element detailed information is displayed, and a “cancel” button for canceling the access to the transition destination and an “OK” button for closing the dialog are provided in the dialog. As described above, not only the element detailed information but also a UI for executing another processing may be displayed. When the user makes an unintentional selection (clicking), he or she can click the “cancel” button to request for canceling of the transition. When the “cancel” button is clicked, a rendering cancel request designating the URL of the rendering result image is transmitted to the cloud server 101. When the generation of the rendering result for the designated URL by the cloud server 101 is in progress, the generation processing can be stopped.

For example, when the “cancel” request is received from the client device 102 in a state where the transition destination has not been rendered by the cloud server 101 yet in the processing in S606, the transition can be cancelled. In response to the “cancel” request, the cloud server 101 returns a response indicating whether the request has been successfully cancelled. The client device 102 that has received the response displays, on the UI, whether the cancellation has been successful after the dialog has been closed. When the cancellation fails, the rendering result image received is displayed thereafter. On the other hand, when the cancellation is successful, the rendering result image is not received or displayed.

### Third Embodiment

In the first embodiment, an example in which the anchor element is the predetermined element is described. In the present embodiment, an example in which a submit type input element is the predetermined element will be described.

FIG. 11 illustrates an example of an HTML representation of the submit type input element according to the present embodiment. In FIG. 11, the destination of transition as a result of clicking a Submit button is designated by an action element in an action attribute of a form element, which is the parent element of the input element.

### Processing in Cloud Server 101

Regarding the processing in the cloud server 101 according to the present embodiment, differences from FIG. 6 will be mainly described. In S603, the identification unit 508 identifies a user operation target element and determines whether the element is the predetermined component. In the present embodiment, the submit type input element is the predetermined element. When the user operation target element is the submit type input, the processing proceeds to S604. When the user operation target element is not the submit type input, the processing proceeds to S605.

In S604, the element detailed information acquisition unit 510 acquires the transition destination of a submit element as the element detailed information. The transition destination of the submit element can be designated by a formaction attribute of the input element. Still, in the case illustrated in FIG. 11, formaction is not designated for the input element. In this case,/submit_page.php, which is the destination designated by the action attribute value of the form element as the parent element, is accessed, and this value is returned as the element detailed information. As described above, the detailed information may be acquired not from the user operation target element itself but from an element related to such an element. The detailed information may differ among predetermined elements.

### Variation Example

In each of the above-described embodiments, an example is described in which the UI rendering unit 404 renders a rectangle surrounding an element or renders a speech bubble or a dialog including an element content and a URL as a transition destination, but the embodiments are not limited to these examples. As long as the user can recognize that he or she has touched or clicked on the link, highlighting display may be implemented by another method. For example, the color of the character of the link may be changed, or the character may be changed to a bold character.

The present disclosure enables the user to swiftly recognize the selected element, while reducing the processing time.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-094507, filed Jun. 11, 2024, which is hereby incorporated by reference herein in its entirety.

What is claimed is:

1. An information processing system configured to transmit a rendering result obtained by processing web content in a first information processing device to a second information processing device and cause the second information processing device to display the rendering result, wherein
the first information processing device includes
a reception unit configured to receive information related to a user operation on the web content from the second information processing device,
an element acquisition unit configured to acquire an element that is a target of the user operation,
an information acquisition unit configured to acquire detailed information of the element when the element is a predetermined element, and
a transmission unit configured to transmit the detailed information to the second information processing device, and
the second information processing device includes
a reception unit configured to receive the detailed information, and
a rendering unit configured to render, on the web content, a user interface related to the user operation, based on the detailed information.

2. The information processing system according to claim 1, wherein the first information processing device further includes
a determination unit configured to determine whether the rendering result is a rendering result involving a page transition of the web content,
a visualization unit configured to visualize the rendering result determined to involve the page transition,
a request reception unit configured to receive an image acquisition request from the second information processing device, and
a result transmission unit configured to transmit to the second information processing device, the rendering result visualized by the visualization unit in response to the reception of the image acquisition request.

3. The information processing system according to claim 2, wherein the second information processing device further includes
a request transmission unit configured to transmit the image acquisition request to the first information processing device,
a result reception unit configured to receive the rendering result from the first information processing device, and
a display unit configured to display the rendering result received by the result reception unit after the rendering by the rendering unit.

4. The information processing system according to claim 1, wherein the detailed information includes information defining a rectangle surrounding the element.

5. The information processing system according to claim 4, wherein the information defining the rectangle includes information on upper left coordinates of the rectangle, a width of the rectangle, and a height of the rectangle.

6. The information processing system according to claim 4, wherein the rendering unit of the second information processing device renders the rectangle surrounding the element.

7. The information processing system according to claim 1, wherein the detailed information includes an element content of the element and a URL of a transition destination.

8. The information processing system according to claim 7, wherein the rendering unit of the second information processing device renders a speech bubble including the element content and the URL of the transition destination.

9. The information processing system according to claim 7, wherein the rendering unit of the second information processing device renders a dialog including the element content and the URL of the transition destination.

10. The information processing system according to claim 9, wherein the dialog includes a button for canceling the transition to the transition destination and a button for closing the dialog.

11. The information processing system according to claim 1, wherein the predetermined element is an anchor element describing a hyperlink.

12. The information processing system according to claim 1, wherein the predetermined element is a submit type input element.

13. The information processing system according to claim 1, wherein the information related to the user operation includes content and input coordinates of mouse input or touch input.

14. The information processing system according to claim 1, wherein
the first information processing device is a cloud server, and
the second information processing device is a client device.

15. An information processing device configured to transmit a rendering result obtained by processing web content to another information processing device and cause the other information processing device to display the rendering result, the information processing device comprising:
a reception unit configured to receive information related to a user operation on the web content from the other information processing device;
an element acquisition unit configured to acquire an element that is a target of the user operation;
an information acquisition unit configured to acquire detailed information of the element when the element is a predetermined element; and
a transmission unit configured to transmit the detailed information to the other information processing device.

16. An information processing device configured to receive from another information processing device, a rendering result obtained by the other information processing device by processing web content, and to display the rendering result, the information processing device comprising:
a transmission unit configured to transmit information related to a user operation on the information processing device to the other information processing device;
a reception unit configured to receive a response from the other information processing device; and
a rendering unit configured to render on the web content, a user interface related to the user operation based on detailed information of an element that is a target of the user operation, when the response includes the detailed information.

17. A control method for an information processing device configured to transmit a rendering result obtained by processing web content to another information processing device and cause the other information processing device to display the rendering result, the control method comprising:
receiving information related to a user operation on the web content from the other information processing device;
acquiring an element that is a target of the user operation;
acquiring detailed information of the element when the element is a predetermined element; and
transmitting the detailed information to the other information processing device.

18. A control method for an information processing device configured to receive from another information processing device, a rendering result obtained by the other information processing device by processing web content, and to display the rendering result, the control method comprising:
transmitting information related to a user operation on the information processing device to the other information processing device;
receiving a response from the other information processing device; and
rendering on the web content, a user interface related to the user operation based on detailed information of an element that is a target of the user operation, when the response includes the detailed information.

19. A storage medium storing a program causing a computer to perform a control method for an information processing device configured to transmit a rendering result obtained by processing web content to another information processing device and cause the other information processing device to display the rendering result, the control method comprising:
receiving information related to a user operation on the web content from the other information processing device;
acquiring an element that is a target of the user operation;
acquiring detailed information of the element when the element is a predetermined element; and
transmitting the detailed information to the other information processing device.

20. A storage medium storing a program causing a computer to perform a control method for an information processing device configured to receive from another information processing device, a rendering result obtained by the other information processing device by processing web content, and to display the rendering result, the control method comprising:
transmitting information related to a user operation on the information processing device to the other information processing device;
receiving a response from the other information processing device; and
rendering on the web content, a user interface related to the user operation based on detailed information of an element that is a target of the user operation, when the response includes the detailed information.
